(19) United States
(12) Patent Application Publication
(10) Pub. No.: US 2026/0244591 A1
(43) Pub. Date: Aug. 20, 2026

(54) OPTIMIZED BUS ARBITRATION FOR ATOMIC TRANSFER REQUESTS FROM MULTIPLE PROCESSORS

(71) Applicant: QUALCOMM Incorporated, San Diego, CA (US)

(72) Inventors: Bhavya SONETA, Indore (IN); Akshay GOYAL, Bijnor (IN)

(21) Appl. No.: 19/059,172

(22) Filed: Feb. 20, 2025

(51) Int. Cl. G06F 13/42

(52) U.S. Cl. CPC G06F 13/4282; G06F 2213/0002

(57) ABSTRACT

Aspects relate to serial bus arbitration optimization for atomic transfer requests from multiple processing devices. A serial bus controller can be configured to receive an atomic transfer request for a serial bus from a processing device of a plurality of processing devices. The atomic transfer request can include a set of operations, each having a format that includes a lock/unlock bit. The serial bus controller can sequentially process each operation of the set of operations having the bit set to lock until reaching a last operation of the set of operations having the bit set to unlock. The serial bus controller may then arbitrate access to the serial bus among the plurality of processing devices in response to the last operation having the bit set to unlock.

### TECHNICAL FIELD

The technology discussed below relates generally to serial bus arbitration among a plurality of processors, and more particularly, to optimized bus arbitration of atomic transfer requests.

### INTRODUCTION

System-on-chip (SoC) technology enables integration of multiple processors (e.g., central processing units (CPUs), graphic processing units (GPUs), neural signal processors (NSPs), digital signal processors (DSPs), memory controllers, etc.) onto a single chip. Multiple processors on the SoC may be coupled to a sensor or other peripheral via a serial bus that is shared between the processors. A serial bus controller coupled to the serial bus can arbitrate access to the serial bus among the processors. For example, the serial bus controller can arbitrate transfer requests (e.g., read requests or write requests) queued from different processors on the serial bus. Transfer requests may be queued as single transfer requests (e.g., a single read or write request) or atomic transfer requests, which are batch transfer requests that allow multiple transfer requests (e.g., multiple read and/or write requests) to be queued at one time, forming an atomic unit of execution.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus is provided that includes a serial bus, a plurality of processing devices configured to share access to the serial bus, and a serial bus controller configured to receive an atomic transfer request for a serial bus from a processing device of a plurality of processing devices configured to share access to the serial bus. The atomic transfer request includes a set of operations, each having a format including a bit set to lock or unlock. The serial bus controller is further configured to sequentially process each operation of the set of operations having the bit set to lock until reaching a last operation of the set of operations having the bit set to unlock and arbitrate access to the serial bus among the plurality of processing devices based on the last operation having the bit set to unlock.

Another example provides a method operable at a serial bus controller. The method includes receiving an atomic transfer request for a serial bus from a processing device of a plurality of processing devices configured to share access to the serial bus. The atomic transfer request includes a set of operations, each having a format including a bit set to lock or unlock. The method further includes sequentially processing each operation of the set of operations having the bit set to lock until reaching a last operation of the set of operations having the bit set to unlock, and arbitrating access to the serial bus among the plurality of processing devices based on the last operation having the bit set to unlock.

Another example provides an apparatus including means for receiving an atomic transfer request for a serial bus from a processing device of a plurality of processing devices configured to share access to the serial bus. The atomic transfer request includes a set of operations, each having a format including a bit set to lock or unlock. The apparatus further includes means for sequentially processing each operation of the set of operations having the bit set to lock until reaching a last operation of the set of operations having the bit set to unlock, and means for arbitrating access to the serial bus among the plurality of processing devices based on the last operation having the bit set to unlock.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram depicting an apparatus employing a system-on-chip (SoC) according to some aspects.

FIG. 2 is a diagram depicting an apparatus including a serial bus in accordance with some aspects of the disclosure.

FIG. 3 is a diagram illustrating an example of a set of buffers configured to support serial interface transfer requests according to some aspects.

FIG. 4 is a diagram depicting an apparatus including a plurality of processors according to some aspects.

FIG. 5 is a diagram illustrating logical serial bus scheduler instances according to some aspects.

FIG. 6 is a diagram illustrating an example of a lock and unlock mechanism.

FIG. 7 is a diagram illustrating an example of a lock and unlock mechanism according to some aspects.

FIG. 8 is a diagram illustrating another example of a lock and unlock mechanism according to some aspects.

FIG. 9 is a flow chart illustrating an exemplary process for optimizing bus arbitration according to some aspects.

FIG. 10 is a flow chart illustrating another exemplary process for optimizing bus arbitration according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware or software depends upon the particular application and design constraints imposed on the overall system.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of described examples. It is intended that innovations described herein may be practiced in a wide variety of devices, chip-level components, systems, distributed arrangements, end-user devices, etc., of varying sizes, shapes, and constitution.

An apparatus, such as a mobile device, internet of things (IoT) device, automotive product or other device, may include a plurality of processing devices and one or more serial buses, each of which may be shared among two or more processing devices of the plurality of processing devices. A serial bus controller may be coupled to the serial buses and arbitrate access to the serial buses among the plurality of processing devices. Each processing device may be configured to queue an atomic transfer request including, for example, a plurality of read and/or write requests to the serial bus controller. To prevent interleaving among atomic transfer requests queued from the different processing devices, the serial bus controller can provide a mechanism for each processing device to lock the serial bus to complete an atomic transfer and then unlock the serial bus after the atomic transfer is completed. Without lock and unlock, the serial bus controller may initiate arbitration as soon as one of the read or write requests within an atomic transfer request is completed, hence leading to interleaving of transfers between different processing devices.

The lock/unlock mechanism may be implemented using lock/unlock operations added to the beginning/end of the atomic transfer request. The lock operation can lock the serial bus until completion of each of the operations in the atomic transfer request. The unlock operation can unlock the serial bus after completion of each of the operations in the atomic transfer request. However, the processing of each lock and unlock operation adds to the processing overhead of the serial bus controller. The added processing overhead further increases linearly with the number of processing devices. Moreover, adding lock and unlock operations requires the use of valuable memory space to store the additional lock/unlock operations.

In various aspects of the disclosure, to reduce processing overhead and save memory space, the individual operations of atomic transfer requests can be modified to include a lock/unlock bit. For example, each operation of the set of operations of an atomic transfer request may have a format (e.g., of a descriptor of the operation) that includes a lock/unlock bit. The serial bus controller can sequentially process each operation of the set of operations having the bit set to lock until reaching a last operation of the set of operations having the bit set to unlock. The serial bus controller may then arbitrate access to the serial bus among the plurality of processing devices in response to the last operation having the bit set to unlock.

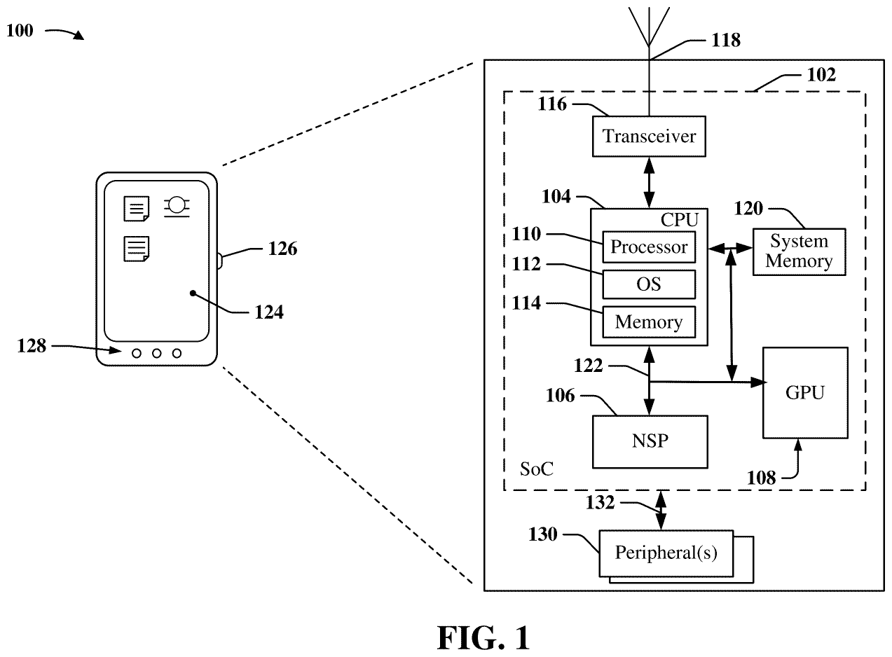

FIG. 1 is a diagram depicting an apparatus employing a system-on-chip (SoC) according to some aspects. In one example, the apparatus 100 may include a radio communication device that communicates through a radio frequency (RF) communications transceiver 116 and antenna 118 (e.g., antenna array) with a radio access network (RAN), a core access network, the Internet and/or another network. In other examples, the apparatus 100 may include other types of devices, including, for example, IoT devices, wearable devices, tablets, or automotive products, which may or may not include the transceiver 116 and/or antenna 118. The communications transceiver 116 may be embodied in, or coupled to a SoC 102 (the former being illustrated).

The SoC 102 may further include a central processing unit (CPU) 104, one or more neural signal processors (NSPs) 106, and one or more graphics processing units (GPUs) 108. In an example, the CPU 104 may include a processor 110 and system memory 114 (e.g., L1 and/or L2 caches or registers or RAM), and may be controlled by an operating system 112 that is loaded from internal or external storage as data and instructions that are executable by the processor 110. The apparatus 100 may further include or access system memory 120 (e.g., DDR, SDRAM, or other memory device). The system memory 120 can be used to maintain data, operational parameters, and other information used to configure and operate the apparatus 100. Each processor 104, 106, and 108 may have a respective execution environment (e.g., a separate address space in the memory 120 and a separate interrupt line). The CPU 104 may also be operably coupled to internal and/or external devices such as a display/user interface 124, operator controls, such as buttons 126, 128, and other components. The CPU 104, NSP 106, GPU 108, and system memory 120

A system bus 122 may be provided to support communication between the SoC components (e.g., CPU 104, NSP 106, GPU 108, and system memory 120). In addition, a data communication interface (e.g., serial bus) 132 may be provided to support communication between the SoC components (e.g., CPU 104, NSP, 106, GPU 108, and/or system memory 120) and one or more peripherals 130. The system bus 122 and data communication interface 132 may be operated in accordance with standard protocols defined for interconnecting certain components of devices. There may be multiple types of interfaces defined for communications between the processors (e.g., CPU 104, NSP 106, GPU 108, etc.) of the SoC 102 and different peripherals 130, such as a touch screen, display, operator controls, fingerprint sensor, gyroscope, and camera components of a device. In some examples, the data communication interface 132 may be operated in accordance with various serial bus protocols including, but not limited to, inter-integrated circuit (I2C), improved inter-integrated circuit (I3C), serial peripheral interface (SPI), universal asynchronous receiver/transmitter (UART), and/or controller area network (CAN).

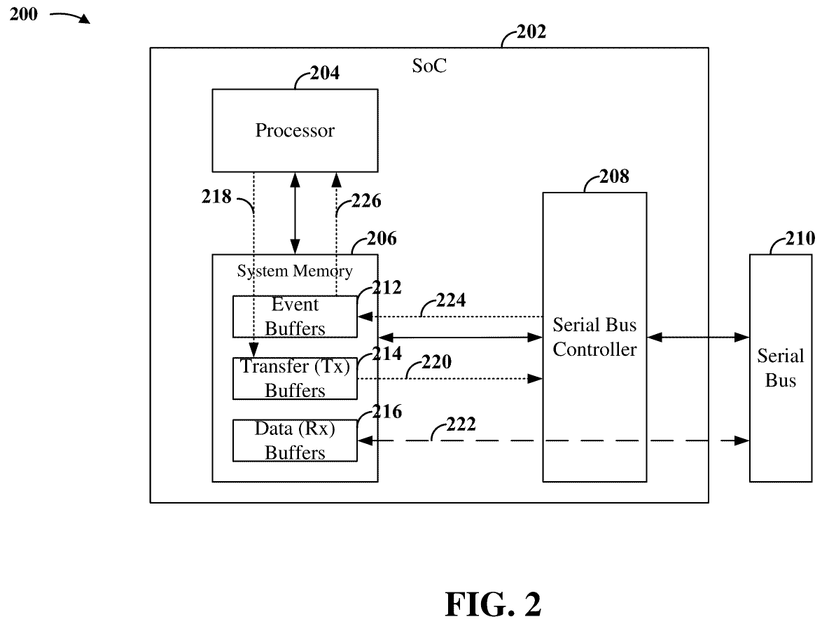

FIG. 2 is a diagram depicting an apparatus including a serial bus in accordance with some aspects of the disclosure. In this example, the apparatus 200 can be a communication device, IoT device, wearable device, tablet, automotive product, or other suitable device. The apparatus 200 includes a SoC 202 including one or more processors (e.g., one exemplary processor 204 shown in FIG. 2) that can be configured to perform various functions of the apparatus, including, for example, application specific functions. In some examples, the processor 204 may include a microprocessor, a microcontroller, an embedded controller, a logic circuit, digital signal processor (DSP), field programmable gate arrays (FPGA), programmable logic devices (PLD), state machine, gated logic, discrete hardware circuits, ASIC, or any kind of processing device, for performing one or more of the functions described herein as being performed by the apparatus 200.

The SoC 202 further includes system memory 206 (e.g., DDR or SDRAM) and a serial bus controller 208 configured to control access to a serial bus 210 (serial interface). The serial bus 210 may be coupled, for example, to one or more peripherals (e.g., one or more sensors or other peripheral devices). The serial bus controller 208 may include, for example, circuitry (e.g., a programmable logic device (PLD), discrete hardware circuit, ASIC, etc.) configured to manage the serial bus 210. The system memory 206 may include a set of buffers 212, 214, and 216 associated with the processor 204. The buffers may include, for example, event buffers 212, transfer (transmit (Tx)) buffers 214, and data (receive (Rx)) buffers 216. The event buffers 212 are configured to store, for example, completion events indicating completion of an operation (e.g., read or write operation). The transfer (Tx) buffers 214 are configured to store transfer requests and data to be written to a peripheral, whereas the data (Rx) buffers 216 are configured to store data read from a peripheral. The serial bus 210 includes, for example, a set of clock and data lines and can be operated using any suitable serial bus protocol (e.g., I2C, I3C, SPI, UART, etc.).

In the example shown in FIG. 2, the processor 204 is configured to perform a transfer request (e.g., a read request) on the serial bus 210. The data read transfer request may include, for example, a sequence of operations on the serial bus 210. In a first operation, the processor 204 writes a configuration to the peripheral device (e.g., writes device configuration data) on the serial bus. For example, the processor 204 can configure the clock and data lines on the serial bus 210. In a second operation, the processor 204 reads data from the peripheral device on the serial bus 210. In each operation, the processor 204 writes a descriptor (e.g., a device configuration data descriptor or a read descriptor) to the transfer (Tx) buffers 214 at 218 and rings a doorbell (e.g., programs a register in the transfer buffer 214) detected by the serial bus controller 208. The serial bus controller 208 then reads the descriptor in the transfer (Tx) buffers 214 at 220 and performs the operation at 222 (e.g., sends the device configuration data to the peripheral or reads data from the peripheral and writes the data in Rx buffers 216). Once the operation is completed, the serial bus controller 208 writes a completion event to the event buffers 212 at 224 and signals an interrupt to the processor 204. The processor 204 can then process the completion event at 226.

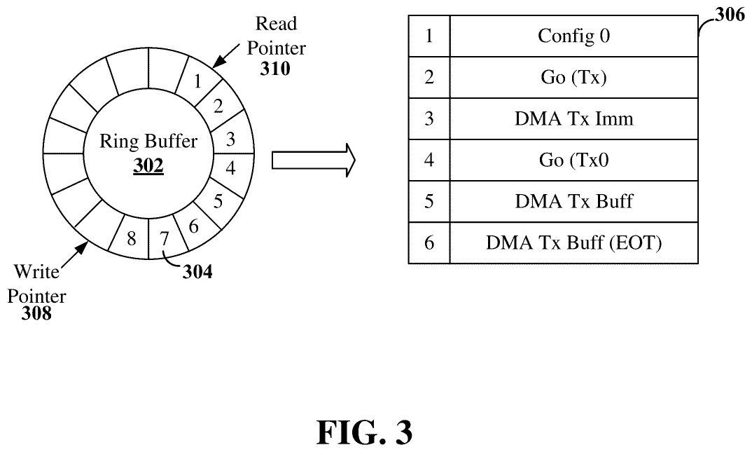

FIG. 3 is a diagram illustrating an example of a set of buffers configured to support serial interface transfer requests according to some aspects. In the example shown in FIG. 3, each buffer 304 may correspond, for example, to a transfer ring element (TRE) of a ring buffer 302 (e.g., circular queue). The ring buffer 302 may include, for example, sixteen TREs 304. Each TRE 304 may be configured to store, for example, sixteen bytes of data (e.g., a descriptor for a configuration or read/write operation). Each TRE 304 represents a unique/different operation 306 of a transfer request. The transfer request operations are loaded into the buffers/TREs 304 in a circular fashion. A write pointer 308 indicates a starting buffer/TRE 304 in the ring buffer 302 to load operations of a new transfer request. The write pointer 308 is incremented for each operation 306 loaded into a TRE 304 (e.g., by a processor) and wraps around at the end to overwrite older data in the ring buffer 302. A read pointer 310 indicates a starting buffer/TRE 304 to read an operation of a transfer request. The read pointer 310 is incremented for each operation read out of a TRE 304 (e.g., each operation read by the serial bus controller). Although a ring buffer configuration is shown in FIG. 3, it should be understood that the present application is not limited to ring buffer configurations or the particular ring buffer configuration shown in FIG. 3.

In some examples, a processor may be configured to load multiple transfer requests into the ring buffer 302 at the same time. The multiple transfer requests may collectively form an atomic transfer request that includes, for example, multiple write requests, multiple read requests, or a combination of read and write requests that collectively form an atomic unit of execution. In the example shown in FIG. 3, the operations 306 stored in the buffers/TREs 304 are associated with multiple write (Tx) requests. For example, the ring buffer 302 is illustrated as storing a configuration descriptor (Config 0) for a configuration operation in a first TRE 304 to configure, for example, clock or data lines on the serial bus, followed by a Tx type descriptor for a next type operation in a second TRE 304, indicating that a first write (Tx) request is to be performed next. The third TRE 304 then includes the Tx (write) descriptor for the first write request operation. For example, the Tx descriptor may include a pointer to a memory address (e.g., a Tx/data buffer in system memory) where data is to be read and placed on the serial bus. The fourth TRE 304 includes a second Tx type descriptor indicating that a second write (Tx) request is to be performed. The fifth and sixth TREs 304 then include the Tx (write) descriptors for the second write request operation.

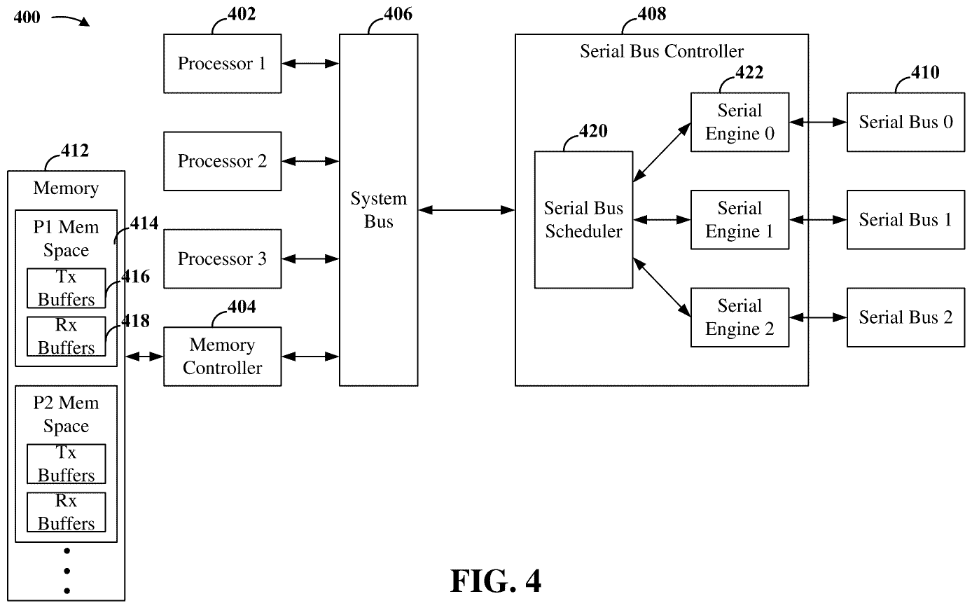

FIG. 4 is a diagram depicting an apparatus including a plurality of processors according to some aspects. The plurality of processors 402 (e.g., three of which (Processor 1, Processor 2, and Processor 3) are shown for convenience) may include, for example, a CPU, NSP, GPU, DSP, or other processing device configured to perform one or more functions of the apparatus, including, for example, application specific functions. Each processor 402 may include or otherwise correspond to an execution environment (EE) of the apparatus (e.g., an operating system/software routine that accepts commands and causes them to be executed). The apparatus 400 (e.g., a mobile device, IoT device, tablet, or automotive device) includes a system bus 406 coupled to the plurality of processors 402. The system bus 406 is further coupled to a memory controller 404, which is coupled to a system memory 412 (e.g., DDR or SDRAM). The memory controller 404 is configured to handle communication between the plurality of processors 402 and the memory 412. The system bus 406 is configured to enable communication between the plurality of processors 402 and the memory 412.

The system memory 412 may include a respective dedicated memory space 414 allocated to each of the plurality of processors 402 (P1 Mem Space, P2 Mem Space, etc.). Each dedicated memory space 414 may include a fixed address region in memory 412. Each dedicated memory space 414 may include a set of buffers 416 and 418 associated with the corresponding processor 402. The buffers may include, for example, transfer/transmit (Tx) buffers 416 and data/receive (Rx) buffers 418. Each memory space 414 associated with each processor 402 may further include event buffers (not shown). In some examples, the buffers 416/418 may include ring buffers including a plurality of TREs.

The apparatus 400 further includes a serial bus controller 408 coupled to the system bus 406. The serial bus controller 408 is further coupled to a plurality of serial buses 410 (e.g., three of which (Serial Bus 0, Serial Bus 1, and Serial Bus 2) are shown for convenience. At least one of the serial buses 410 is shared among two or more of the processors 402. In some examples, each of the serial buses 410 is shared among each of the plurality of processors 402. Each of the serial buses 410 is configured to provide communication between the plurality of processors 402 and one or more peripheral devices (e.g., touch screen, user interface, display, fingerprint sensor, gyroscope, camera components, etc.). Each serial bus 410 includes, for example, a set of clock and data lines and can be operated using any suitable serial bus protocol (e.g., I2C, I3C, SPI, UART, etc.). The serial bus controller 408 includes a plurality of serial engines 422 (e.g., Serial Engine 0, Serial Engine 1, and Serial Engine 2), each configured to support a respective serial bus 410. For example, each serial engine 422 may be configured to support communication with a respective serial bus 410 based on the respective serial bus protocol of the respective serial bus. The particular serial bus protocol of a serial bus 410 may, for example, be programmed via firmware loaded into the corresponding serial engine 422.

The serial bus controller 408 further includes a serial bus scheduler 420 configured to arbitrate access to each of the serial buses 410 among the plurality of processors 402. For example, the serial bus scheduler 420 may be configured to arbitrate transfer requests from different processors/EEs 402 on a particular serial bus 410 that is shared among the processors 402. The serial bus scheduler 420 may be logically represented by a plurality of scheduler instances, each mapping a particular processor 402 to a particular serial engine 422. Each scheduler instance is associated with a respective serial engine 422. Multiple scheduler instances may be mapped to the same processor 402 to support scheduling of the processor 402 on the multiple serial engines 422/serial buses 410. Each scheduler instance may include a Tx/Rx channel pair and an event channel. To facilitate scheduler instance mapping of the processors 402 to serial engines 422, each of the dedicated memory spaces (memory regions) 414, including Tx/Rx buffers 414/416 and event buffers (not shown), may first be assigned to a respective scheduler instance, and then each scheduler instance may be assigned to a processor 402 to create the Tx/Rx channel pairs and event channels between the processor 402 and the serial engine 422.

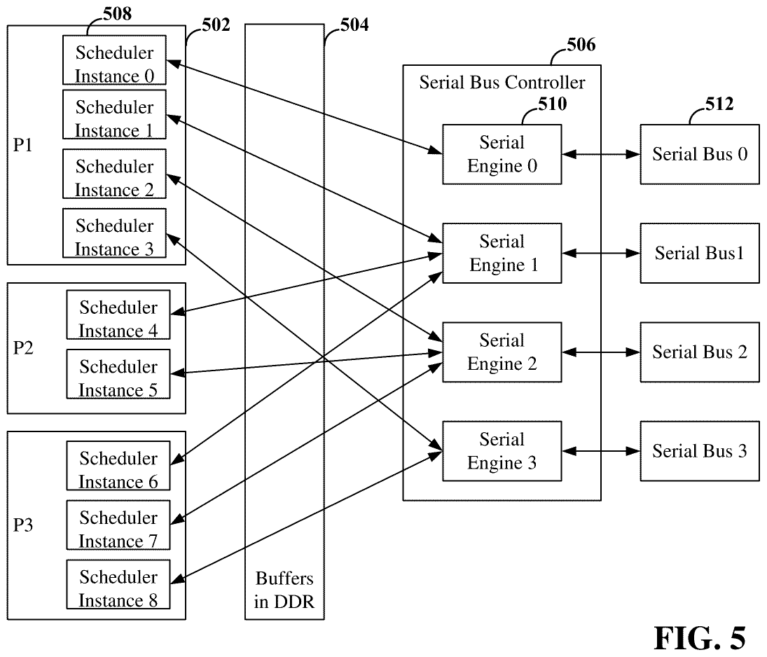

FIG. 5 is a diagram illustrating logical serial bus scheduler instances according to some aspects. In the example shown in FIG. 5, each processor/EE 502 (e.g., P1, P2, P3) can be mapped to a respective serial engine 510 (e.g., Serial Engine 0, Serial Engine 1, Serial Engine 2, Serial Engine 3) within a serial bus controller 506 and respective associated serial bus 512 (e.g., Serial Bus 0, Serial Bus 1, Serial Bus 2, Serial Bus 3) via a respective scheduler instance 508. Multiple scheduler instances 508 may be mapped to each processor 502 to support communication between that processor 502 and multiple serial engines 510/serial buses 512. For example, Scheduler Instance 0 may map processor P1 to Serial Engine 0, Scheduler Instance 1 may map processor P2 to Serial Engine 1, Scheduler Instance 2 may map processor P1 to Serial Engine 2, and Scheduler Instance 3 may map processor P1 to Serial Engine 3. In addition, Scheduler Instance 4 may map processor P2 to Serial Engine 1 and Scheduler Instance 5 may map processor P2 to Serial Engine 2. Furthermore, Scheduler Instance 6 may map processor P3 to Serial Engine 1, Scheduler Instance 7 may map processor P3 to Serial Engine 2, and Scheduler Instance 8 may map processor P3 to Serial Engine 3. Each scheduler instance 508 includes a Tx/Rx channel pair and an event channel, which is facilitated through respective Tx/Rx/Event buffers assigned to each scheduler instance 508 within system memory 504 (e.g., DDR). For example, a respective dedicated memory space (e.g., memory address regions of the Tx/Rx/Event buffers) may be assigned to each scheduler instance 508 within system memory 504, and then each scheduler instance 508 may be assigned to a particular processor 502 to create the Tx/Rx channel pairs and event channels between that processor 502 and the corresponding serial engine 510.

As shown in FIG. 5, Serial Engine 0 and its associated serial bus (Serial Bus 0) is not a shared serial bus. Instead, Serial Engine 0 and its associated serial bus (Serial Bus 0) is dedicated only for processor P1. Therefore, transfer requests, including atomic transfer requests, queued from processor P1 are handled by Scheduler Instance 0 without requiring arbitration among the processors 502/scheduler instances 508. However, Serial Engine 1 and its associated serial bus (Serial Bus 1) is shared among each of the processors 502 (e.g., P1, P2, and P3). Similarly, Serial Engine 2 and its associated serial bus (Serial Bus 2) is shared among each of the processors 502. In addition, Serial Engine 3 and its associated serial bus (Serial Bus 3) is shared among processors P2 and P3.

For each of the shared serial buses 512, to ensure that no interleaving occurs among atomic transfer requests queued from the different processors 502, the serial bus scheduler (420, shown in FIG. 4) can provide a mechanism for each processor 502 to lock the serial bus 512 to complete an atomic transfer and then unlock the serial bus 512 after the atomic transfer is completed by that processor 502. Without lock and unlock, the serial bus scheduler may initiate arbitration as soon as one of the read or write requests within an atomic transfer request is completed, hence leading to interleaving of transfers between different processors 502/scheduler instances 508. The lock/unlock mechanism thus prevents arbitration during critical transfers, ensuring uninterrupted operations.

For example, if Scheduler Instance 1 queues an atomic transfer request including ten write requests, Schedule Instance 4 queues an atomic transfer request including two read requests, and Scheduler Instance 6 queues an atomic transfer request including four write requests, without a lock on the bus, once the serial bus scheduler completed the first write request on Scheduler Instance 1, the serial bus scheduler may initiate arbitration and switch to Scheduler Instance 4 to complete one of the read requests. The serial bus scheduler may then switch to Scheduler Instance 6 to complete one of the write requests before processing the second write request of Scheduler Instance 0. By having a lock on the bus, the serial bus scheduler can complete all operations of the atomic transfer request on Scheduler Instance 0 before starting arbitration to select another atomic transfer request (e.g., the atomic transfer requests queued by Scheduler Instance 4). The serial bus scheduler may then finish all operations of the atomic transfer request on Scheduler Instance 4 before switching to the atomic transfer request on Scheduler Instance 6.

Thus, once the channel pair of Scheduler Instance 1 gains exclusivity on Serial Engine 1 using the locking mechanism, all other channel pairs mapped to Serial Engine 1 (e.g., the channel pairs from Scheduler Instance 4 and Scheduler Instance 6) are considered locked down internally by the serial bus controller 506. As a result, the serial bus scheduler will disregard any doorbells and TREs indications coming from the other channel pairs. At the same time, channel pairs mapped to other serial engines (e.g., Serial Engines 0, 2, and 3) are able to queue atomic transfer requests to the other serial engines to attempt to gain exclusivity thereto (e.g., using the locking mechanism).

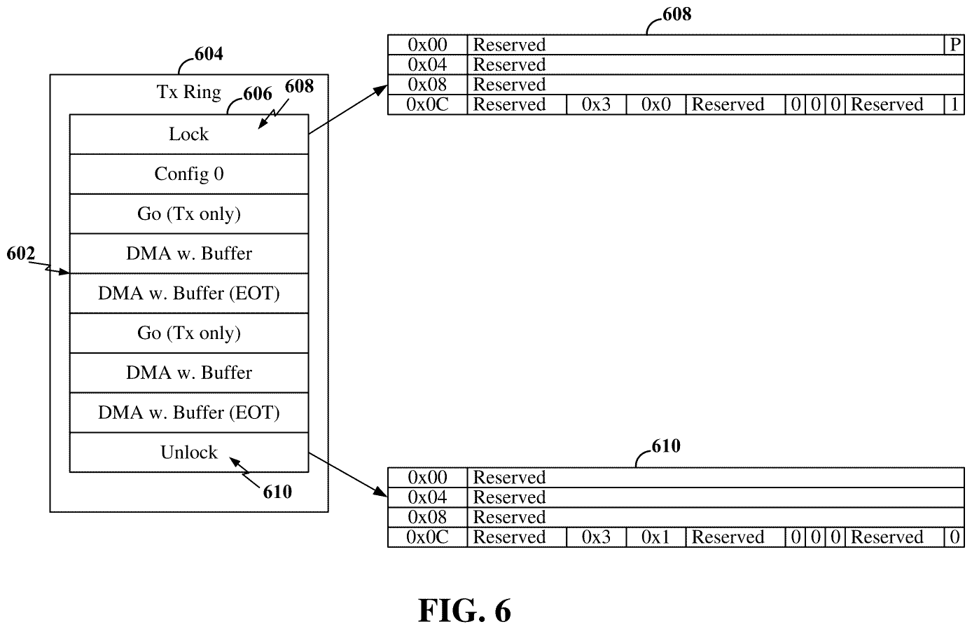

FIG. 6 is a diagram illustrating an example of a lock and unlock mechanism. In the example shown in FIG. 6, an atomic transfer request 602 including a set of operations is loaded into a respective set of buffers 606 (e.g., TREs) of a ring buffer 604. In addition, a lock operation 608 is loaded into the ring buffer 604 in an initial TRE 606 prior to the first operation of the atomic transfer request 602 and an unlock operation 610 is loaded into the ring buffer 604 in a last TRE 606 at the end of the atomic transfer request 602. The lock operation 608 locks the serial bus until completion of each of the operations in the atomic transfer request 602. Thus, upon processing the lock operation 608, the serial bus controller locks the serial bus to process in sequence all operations in the atomic transfer request 602 until processing the unlock operation 610 to prevent interleaving among processors/EEs on the serial bus. The unlock operation 610 unlocks the serial bus after completion of each of the operations in the atomic transfer request. The processing of each lock operation 608 and unlock operation 610 adds to the processing overhead of the serial bus controller. The more processors (e.g., in a multi-processor/multi-EE configuration), the greater the processing overhead. Moreover, adding lock and unlock operations 608 and 610 to the TREs 606 takes valuable memory space in the ring buffer 604 that could be used for other transfer requests.

Therefore, various aspects are directed to a lock and unlock mechanism that reduces processing overhead and saves memory space. Instead of loading additional lock and unlock operations into the ring buffer (lock/unlock TREs), the individual operations of atomic transfer requests can be modified to include a lock/unlock bit. Thus, each TRE can include a lock/unlock bit.

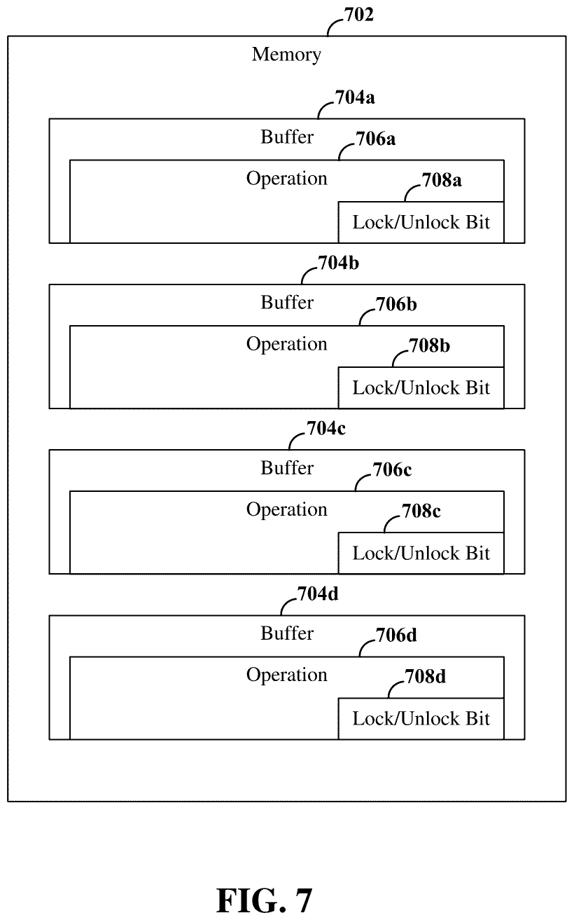

FIG. 7 is a diagram illustrating an example of a lock and unlock mechanism according to some aspects. In the example shown in FIG. 7, a memory 702 may include a set of buffers 704a-704d (e.g., TREs of a ring buffer, four of which are shown for convenience). Each buffer 704a-704d may be configured to store a respective operation 706a-706d for execution thereof. In addition, each operation 706a-706d may include a respective lock/unlock bit 708a-708d to implement a lock/unlock feature. For example, if the lock/unlock bit 708a is set to lock (e.g., “1”), a serial bus scheduler (e.g., serial bus scheduler 420, shown in FIG. 4) may treat the operation 706a as part of an atomic transfer request and process each operation 706a-708d in the atomic transfer request in sequence until the serial bus scheduler encounters an operation (e.g., operation 706d) with the lock/unlock bit 708d set to unlock (e.g., “0”).

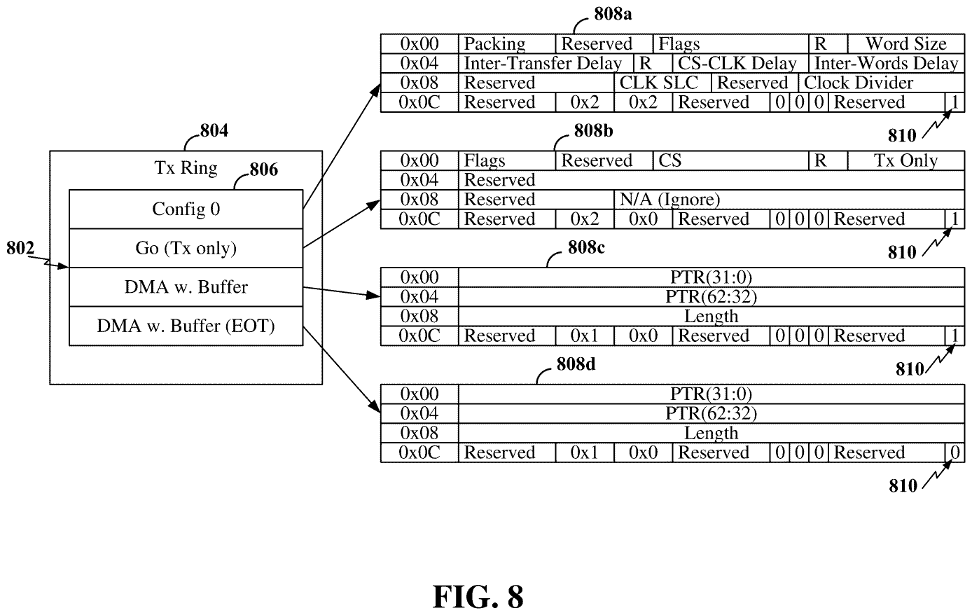

FIG. 8 is a diagram illustrating another example of a lock and unlock mechanism according to some aspects. In the example shown in FIG. 8, a transfer request 802 including a set of operations 808a-808d is loaded into a respective set of buffers 806 (e.g., TREs) of a ring buffer 804. Each operation 808a-808d has a respective format that includes a respective bit 810 to implement the lock/unlock feature. The bit 810 may correspond to a respective chain bit in each TRE 806 or a different bit. If the bit 810 is set to lock (e.g., “1”), the serial bus scheduler (e.g., serial bus scheduler 420, shown in FIG. 4) may treat the transfer request 802 as an atomic transfer request and process each operation 808a-808d in the transfer request 802 in sequence until the serial bus scheduler encounters an operation 808d/TRE 806 with the bit 810 set to unlock (e.g., “0”). Thus, the serial bus scheduler (420, shown in FIG. 4) is configured to identify and complete one atomic transfer per processor (e.g., scheduler instance 508, shown in FIG. 5) using the lock/unlock bit 810.

To implement the lock/unlock feature, each of the processors (e.g., processors 204, 402, and/or 502 shown in FIGS. 2, 4, and/or 5) are configured to identify and set the lock/unlock bit for each operation of a transfer request (e.g., an atomic transfer request) loaded into the ring buffer 804. For example, the respective software (e.g., an operating system or application) executed by each EE/processor may be configured to set the lock/unlock bit. In addition, the serial bus scheduler 420 and serial bus controller 208, 408, and/or 506 shown in FIGS. 2, 4, and/or 5 are configured to process the lock/unlock bits, complete atomic transfer requests with the lock/unlock bit set to lock, and initiate arbitration upon completion of a transfer request with the lock/unlock bit set to unlock.

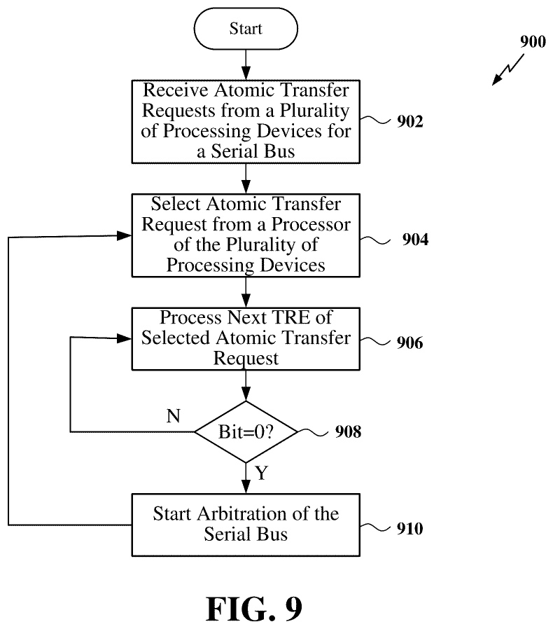

FIG. 9 is a flow chart illustrating an exemplary process 900 for optimizing bus arbitration according to some aspects. As described below, some or all illustrated features may be omitted in a particular implementation within the scope of the present disclosure, and some illustrated features may not be required for implementation of all embodiments. In some examples, the process 900 may be carried out by the serial bus controller 208 shown in FIG. 2, the serial bus scheduler 420 and serial bus controller 408 shown in FIG. 4, and/or the serial bus controller 506 shown in FIG. 5. In some examples, the process 900 may be carried out by any suitable apparatus or means for carrying out the functions or algorithm described below.

At block 902, the process begins with receiving respective atomic transfer requests from a plurality of processing devices (e.g., processors/EEs) for a serial bus. Each atomic transfer request may include a set of operations, which may include, for example, one or more of a read request or a write request. In some examples, one or more of the atomic transfer requests may include two or more read requests, two or more write requests, or both one or more read requests and one or more write requests. Each of the atomic transfer requests may be queued, for example, to the serial bus scheduler in the serial bus controller. For example, the set of operations for an atomic transfer request may be loaded into a ring buffer associated with the processor, with each TRE of the ring buffer including a descriptor of a respective operation. The descriptor has a format that can include, for example, a lock/unlock bit.

At block 904, the process continues with selecting an atomic transfer request of the plurality of atomic transfer requests for processing. For example, the serial bus scheduler may arbitrate among the plurality of processing devices using any bus arbitration mechanism to select one of the plurality of atomic transfer requests.

At block 906, the process continues with processing a TRE of the selected atomic transfer request. For example, the serial bus controller may process a first operation of the atomic transfer request included within the TRE of a ring buffer containing the atomic transfer request. The operation may include, for example, a configuration operation (e.g., to configure the serial engine/serial bus), a next type operation (e.g., indicating whether the next operation is a read operation or a write operation), a read operation, a write operation, or other suitable operation.

At block 908, the process continues with determining whether the lock/unlock bit in the TRE is set to unlock (e.g., set to “0”). If the lock/unlock bit is set to lock (e.g., set to “1”), the process continues at block 906, where the serial bus controller processes a next TRE of the selected atomic transfer request. However, if the lock/unlock bit is set to unlock, the process continues at block 910 with starting arbitration of the serial bus to select another atomic transfer request at block 904.

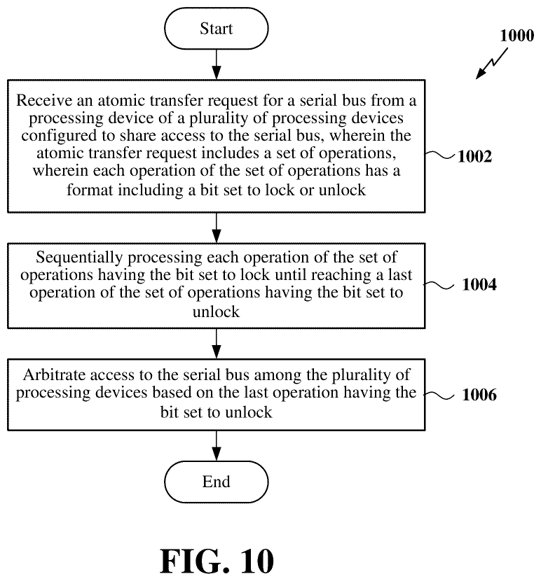

FIG. 10 is a flow chart illustrating another exemplary process 1000 for optimizing bus arbitration according to some aspects. As described below, some or all illustrated features may be omitted in a particular implementation within the scope of the present disclosure, and some illustrated features may not be required for implementation of all embodiments. In some examples, the process 1000 may be carried out by the serial bus controller 208 shown in FIG. 2, the serial bus scheduler 420 and serial bus controller 408 shown in FIG. 4, and/or the serial bus controller 506 shown in FIG. 5. In some examples, the process 1000 may be carried out by any suitable apparatus or means for carrying out the functions or algorithm described below.

At block 1002, the process begins with receiving an atomic transfer request for a serial bus from a processing device of a plurality of processing devices configured to share access to the serial bus. The atomic transfer request includes a set of operations, and each operation of the set of operations has a format including a bit set to lock or unlock. In some examples, the atomic transfer request includes one or more of a read request or a write request. In some examples, the process further includes receiving a plurality of atomic transfer requests including the atomic transfer request, each being received from a respective processing device of the plurality of processing devices, and selecting the atomic transfer request from among the plurality of atomic transfer requests for processing.

At block 1004, the process continues with sequentially processing each operation of the set of operations having the bit set to lock until reaching a last operation of the set of operations having the bit set to unlock. In some examples, the set of operations are loaded into respective buffers associated with the processing device. In some examples, the respective buffers include transfer ring elements of one or more ring buffers within a memory. In some examples, the respective buffers are assigned to a serial bus scheduler instance of the serial bus scheduler, and the serial bus scheduler instance is assigned to the serial bus and to the processing device.

At block 1006, the process continues with arbitrating access to the serial bus among the plurality of processing devices based on the last operation having the bit set to unlock. In some examples, the process further includes selecting an additional atomic transfer request from among the plurality of atomic transfer requests from an additional processing device of the plurality processing devices. For example, the additional atomic transfer request can include an additional set of operations loaded into additional respective buffers associated with the additional processing device. In this example, the process can include sequentially processing each additional operation of the additional set of operations having the bit set to lock until reaching a last additional operation of the additional set of operations having the bit set to unlock.

In some examples, the serial bus is one of a plurality of serial buses accessible to the plurality of processing devices. In this example, the process can further include arbitrating access to each serial bus of the plurality of serial buses among the plurality of processing devices based on respective atomic transfer requests received for each of the plurality of serial buses from the plurality of processing devices.

In one configuration, an apparatus includes means for receiving an atomic transfer request for a serial bus from a processing device of a plurality of processing devices configured to share access to the serial bus, wherein the atomic transfer request comprises a set of operations, wherein each operation of the set of operations comprises a format including a bit set to lock or unlock, means for sequentially processing each operation of the set of operations having the bit set to lock until reaching a last operation of the set of operations having the bit set to unlock, and means for arbitrating access to the serial bus among the plurality of processing devices based on the last operation having the bit set to unlock. In one aspect, the aforementioned means may be the serial bus controller 208 shown in FIG. 2, the serial bus scheduler 420 and serial bus controller 408 shown in FIG. 4, and/or the serial bus controller 506 shown in FIG. 5 configured to perform the functions recited by the aforementioned means. In another aspect, the aforementioned means may be a circuit or any apparatus configured to perform the functions recited by the aforementioned means.

Of course, in the above examples, the serial bus controller is merely provided as an example, and other means for carrying out the described functions may be included within various aspects of the present disclosure, including any other suitable apparatus or means described in any one of the FIGS. 1-5, and utilizing, for example, the processes and/or algorithms described herein in relation to FIGS. 8 and 9.

The following provides an overview of aspects of the present disclosure:
Aspect 1: An apparatus, comprising: a serial bus; a plurality of processing devices configured to share access to the serial bus; and a serial bus controller configured to: receive an atomic transfer request for a serial bus from a processing device of a plurality of processing devices configured to share access to the serial bus, wherein the atomic transfer request comprises a set of operations, wherein each operation of the set of operations comprises a format including a bit set to lock or unlock; sequentially process each operation of the set of operations having the bit set to lock until reaching a last operation of the set of operations having the bit set to unlock; and arbitrate access to the serial bus among the plurality of processing devices based on the last operation having the bit set to unlock.
Aspect 2: The apparatus of aspect 1, wherein the atomic transfer request comprises one or more of a read request or a write request.
Aspect 3: The apparatus of aspect 1 or 2, wherein the serial bus controller is further configured to: receive a plurality of atomic transfer requests including the atomic transfer request, wherein each of the plurality of atomic transfer requests is received from a respective processing device of the plurality of processing devices; and select the atomic transfer request from among the plurality of atomic transfer requests for processing.
Aspect 4: The apparatus of aspect 3, wherein the serial bus controller is further configured to arbitrate access to the serial bus by: selecting an additional atomic transfer request from among the plurality of atomic transfer requests from an additional processing device of the plurality of processing devices.
Aspect 5: The apparatus of aspect 4, wherein the additional atomic transfer request comprises an additional set of operations loaded into respective buffers associated with the additional processing device, and wherein the serial bus controller is further configured to: sequentially process each additional operation of the additional set of operations having the bit set to lock until reaching a last additional operation of the additional set of operations having the bit set to unlock.
Aspect 6: The apparatus of any of aspects 1 through 5, further comprising: a memory comprising respective buffers into which the set of operations are loaded, wherein the respective buffers are associated with the processing device.
Aspect 7: The apparatus of aspect 6, wherein the respective buffers comprise transfer ring elements of one or more ring buffers within a memory.
Aspect 8: The apparatus of aspect 6 or 7, wherein the respective buffers are assigned to a serial bus scheduler instance of a serial bus scheduler of the serial bus controller, wherein the serial bus scheduler instance is assigned to the serial bus and to the processing device.
Aspect 9: The apparatus of any of aspects 1 through 8, wherein the serial bus is one of a plurality of serial buses accessible to the plurality of processing devices, and wherein the serial bus controller is further configured to: arbitrate access to each serial bus of the plurality of serial buses among the plurality of processing devices based on respective atomic transfer requests received for each of the plurality of serial buses from the plurality of processing devices.
Aspect 10: A method operable at a serial bus controller, the method comprising: receiving an atomic transfer request for a serial bus from a processing device of a plurality of processing devices configured to share access to the serial bus, wherein the atomic transfer request comprises a set of operations, wherein each operation of the set of operations comprises a format including a bit set to lock or unlock; sequentially processing each operation of the set of operations having the bit set to lock until reaching a last operation of the set of operations having the bit set to unlock; and arbitrating access to the serial bus among the plurality of processing devices based on the last operation having the bit set to unlock.
Aspect 11: The method of aspect 10, wherein the atomic transfer request comprises one or more of a read request or a write request.
Aspect 12: The method of aspect 10 or 11, further comprising: receiving a plurality of atomic transfer requests including the atomic transfer request, wherein each of the plurality of atomic transfer requests is received from a respective processing device of the plurality of processing devices; and selecting the atomic transfer request from among the plurality of atomic transfer requests for processing.
Aspect 13: The method of aspect 12, wherein the arbitrating access to the serial bus further comprises: selecting an additional atomic transfer request from among the plurality of atomic transfer requests from an additional processing device of the plurality of processing devices.
Aspect 14: The method of aspect 13, wherein the additional atomic transfer request comprises an additional set of operations loaded into respective buffers associated with the additional processing device, and further comprising: sequentially processing each additional operation of the additional set of operations having the bit set to lock until reaching a last additional operation of the additional set of operations having the bit set to unlock.
Aspect 15: The method of any of aspects 10 through 14, wherein the set of operations are loaded into respective buffers associated with the processing device.
Aspect 16: The method of aspect 15, wherein the respective buffers comprise transfer ring elements of one or more ring buffers within a memory.
Aspect 17: The method of aspect 15 or 16, wherein the respective buffers are assigned to a serial bus scheduler instance of a serial bus scheduler of the serial bus controller, wherein the serial bus scheduler instance is assigned to the serial bus and to the processing device.
Aspect 18: The method of any of aspects 10 through 17, wherein the serial bus is one of a plurality of serial buses accessible to the plurality of processing devices, and further comprising: arbitrating access to each serial bus of the plurality of serial buses among the plurality of processing devices based on respective atomic transfer requests received for each of the plurality of serial buses from the plurality of processing devices.
Aspect 19: An apparatus comprising means for performing a method of any of aspects 10 through 18.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-5 may be configured to perform one or more of the methods, features, or steps described herein. The novel algorithms described herein may also be efficiently implemented in software and/or embedded in hardware.

Any reference to an element herein using a designation e.g., “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An apparatus, comprising:
a serial bus;
a plurality of processing devices configured to share access to the serial bus; and
a serial bus controller configured to:
receive an atomic transfer request for a serial bus from a processing device of a plurality of processing devices configured to share access to the serial bus, wherein the atomic transfer request comprises a set of operations, wherein each operation of the set of operations comprises a format including a bit set to lock or unlock;
sequentially process each operation of the set of operations having the bit set to lock until reaching a last operation of the set of operations having the bit set to unlock; and
arbitrate access to the serial bus among the plurality of processing devices based on the last operation having the bit set to unlock.

2. The apparatus of claim 1, wherein the atomic transfer request comprises one or more of a read request or a write request.

3. The apparatus of claim 1, wherein the serial bus controller is further configured to:
receive a plurality of atomic transfer requests including the atomic transfer request, wherein each of the plurality of atomic transfer requests is received from a respective processing device of the plurality of processing devices; and
select the atomic transfer request from among the plurality of atomic transfer requests for processing.

4. The apparatus of claim 3, wherein the serial bus controller is further configured to arbitrate access to the serial bus by:
selecting an additional atomic transfer request from among the plurality of atomic transfer requests from an additional processing device of the plurality of processing devices.

5. The apparatus of claim 4, wherein the additional atomic transfer request comprises an additional set of operations loaded into respective buffers associated with the additional processing device, and wherein the serial bus controller is further configured to:
sequentially process each additional operation of the additional set of operations having the bit set to lock until reaching a last additional operation of the additional set of operations having the bit set to unlock.

6. The apparatus of claim 1, further comprising:
a memory comprising respective buffers into which the set of operations are loaded, wherein the respective buffers are associated with the processing device.

7. The apparatus of claim 6, wherein the respective buffers comprise transfer ring elements of one or more ring buffers within a memory.

8. The apparatus of claim 6, wherein the respective buffers are assigned to a serial bus scheduler instance of a serial bus scheduler of the serial bus controller, wherein the serial bus scheduler instance is assigned to the serial bus and to the processing device.

9. The apparatus of claim 1, wherein the serial bus is one of a plurality of serial buses accessible to the plurality of processing devices, and wherein the serial bus controller is further configured to:
arbitrate access to each serial bus of the plurality of serial buses among the plurality of processing devices based on respective atomic transfer requests received for each of the plurality of serial buses from the plurality of processing devices.

10. A method operable at a serial bus controller, the method comprising:
receiving an atomic transfer request for a serial bus from a processing device of a plurality of processing devices configured to share access to the serial bus, wherein the atomic transfer request comprises a set of operations, wherein each operation of the set of operations comprises a format including a bit set to lock or unlock;
sequentially processing each operation of the set of operations having the bit set to lock until reaching a last operation of the set of operations having the bit set to unlock; and
arbitrating access to the serial bus among the plurality of processing devices based on the last operation having the bit set to unlock.

11. The method of claim 10, wherein the atomic transfer request comprises one or more of a read request or a write request.

12. The method of claim 10, further comprising:
receiving a plurality of atomic transfer requests including the atomic transfer request, wherein each of the plurality of atomic transfer requests is received from a respective processing device of the plurality of processing devices; and
selecting the atomic transfer request from among the plurality of atomic transfer requests for processing.

13. The method of claim 12, wherein the arbitrating access to the serial bus further comprises:
selecting an additional atomic transfer request from among the plurality of atomic transfer requests from an additional processing device of the plurality of processing devices.

14. The method of claim 13, wherein the additional atomic transfer request comprises an additional set of operations loaded into respective buffers associated with the additional processing device, and further comprising:
sequentially processing each additional operation of the additional set of operations having the bit set to lock until reaching a last additional operation of the additional set of operations having the bit set to unlock.

15. The method of claim 10, wherein the set of operations are loaded into respective buffers associated with the processing device.

16. The method of claim 15, wherein the respective buffers comprise transfer ring elements of one or more ring buffers within a memory.

17. The method of claim 15, wherein the respective buffers are assigned to a serial bus scheduler instance of a serial bus scheduler of the serial bus controller, wherein the serial bus scheduler instance is assigned to the serial bus and to the processing device.

18. The method of claim 10, wherein the serial bus is one of a plurality of serial buses accessible to the plurality of processing devices, and further comprising:
arbitrating access to each serial bus of the plurality of serial buses among the plurality of processing devices based on respective atomic transfer requests received for each of the plurality of serial buses from the plurality of processing devices.

19. An apparatus, comprising:
means for receiving an atomic transfer request for a serial bus from a processing device of a plurality of processing devices configured to share access to the serial bus, wherein the atomic transfer request comprises a set of operations, wherein each operation of the set of operations comprises a format including a bit set to lock or unlock;
means for sequentially processing each operation of the set of operations having the bit set to lock until reaching a last operation of the set of operations having the bit set to unlock; and
means for arbitrating access to the serial bus among the plurality of processing devices based on the last operation having the bit set to unlock.

20. The apparatus of claim 19, wherein the atomic transfer request comprises one or more of a read request or a write request.
